(19) United States
(12) Patent Application Publication
(10) Pub. No.: US 2019/0304456 A1
(43) Pub. Date: Oct. 3, 2019

(54) STORAGE MEDIUM, SPOKEN LANGUAGE UNDERSTANDING APPARATUS, AND SPOKEN LANGUAGE UNDERSTANDING METHOD

(71) Applicant: FUJITSU LIMITED, Kawasaki-shi (JP)

(72) Inventor: RYOSUKE HAMASAKI, Yokohama (JP)

(73) Assignee: FUJITSU LIMITED, Kawasaki-shi (JP)

(21) Appl. No.: 16/364,434

(22) Filed: Mar. 26, 2019

(30) Foreign Application Priority Data
Mar. 30, 2018 (JP) 2018-067760

(51) Int. Cl. G10L 15/22; G10L 15/30

(52) U.S. Cl. CPC G10L 15/22; G10L 2015/223; G10L 15/30

(57) ABSTRACT

A non-transitory computer-readable storage medium storing a program that causes a processor included in a spoken language understanding apparatus to execute a process, the process includes executed by a first apparatus that is a computer, executing a first slot filling process for a first slot that corresponds to a first application and a second slot that corresponds to a second application based on a result of first speech recognition executed by the first apparatus for a speech signal, executing determination as to whether a result of a second slot filling process executed for the second slot based on second speech recognition executed for the speech signal by a second apparatus coupled to the first apparatus by a network is employed, based on a result of the first slot filling process, and executing the first application or the second application based on a result of the determination.

### CROSS-REFERENCE TO RELATED APPLICATION

This application is based upon and claims the benefit of priority of the prior Japanese Patent Application No. 2018-67760, filed on Mar. 30, 2018, the entire contents of which are incorporated herein by reference.

### FIELD

The embodiments discussed herein relate to a spoken language understanding program, a spoken language understanding apparatus, and a spoken language understanding method.

### BACKGROUND

With the improvement of the precision of the speech recognition technique, prevalence of applications (pieces of application software) each using the speech recognition has been advanced. These applications include those for various degrees of difficulty, from the one for simple speeches such as a dialogue for greeting to the one for complicated speeches such as a dialogue for purchasing an air ticket.

The application using the speech recognition is executed after spoken language understanding for the result of the speech recognition is executed. The spoken language understanding may be executed using a method called “slot filling.” In the slot filling, a process of filling one or more slots (called “slot set”) prepared for each application, based on the result of the speech recognition (filling) is executed. As an example thereof, in the case of an application that makes a reservation for an air ticket, slots for the task (air ticket reservation), the date, the time of day, the place of departure, the destination, and the like are prepared and the application may be executed by filling these slots based on the result of the speech recognition.

The applications each using the result of the speech recognition include those that each need a large amount of vocabularies for the speech recognition and those that do not. For an application for simple speeches, not a so large amount of vocabularies may be needed. This is because the slots for the application for simple speeches may often be filled based on the result of even the recognition in accordance with the speech recognition needing a small amount of vocabularies. On the other hand, for an application for complicated speeches, a trouble such as that the application does not properly operate arises when the speech recognition capable of using a large amount of vocabularies is not executed. This is because it is often difficult to fill the slots for the application for complicated speeches without using the result of the recognition in accordance with the speech recognition capable of using the large amount of vocabularies.

Because the speech recognition capable of using the large amount of vocabularies uses an abundant computer resource, this speech recognition is executed by a cloud apparatus or the like. In contrast, because the speech recognition using a small amount of vocabularies is executable using even a poor computer resource, this speech recognition is executed by a local terminal such as a personal computer, a tablet, a smartphone, or a mobile phone. Patent Document 1 discloses a technique relating to hybrid speech recognition according to which a local terminal and a cloud apparatus each execute a speech recognition process. As related arts, for example, Japanese Laid-open Patent Publication No. 2013-232001, Japanese Laid-open Patent Publication No. 2006-053470, Japanese Laid-open Patent Publication No. 2016-061954, and Japanese Laid-open Patent Publication No. 2003-058187 are disclosed.

When the application is executed using the speech recognition, a method of manually selecting the application is present while it may also be considered that the application is automatically selected based on the result of the speech recognition. In the case where this automatic selection is realized using the hybrid speech recognition, for example, the following method for this realization may be considered.

The speech recognition is first executed for an input speech by the local terminal, and the input speech is transferred to the cloud apparatus for the cloud apparatus to also execute the speech recognition. Slot filling is next executed for slot sets for an application that does not need any large amount of vocabularies, using the result of the speech recognition executed by the local terminal. The local terminal receives the result of the speech recognition executed by the cloud apparatus and executes slot filling for slot sets for an application that needs the large amount of vocabularies. Thereafter, for the slot sets for which the slot filling is successfully executed (for example, the necessary slots including the key slot are filled), an application corresponding to the slot sets is executed.

The desired functions are realized by executing as above while a problem still remains. For example, for the slot sets corresponding to an application that needs a large amount of vocabularies, it is difficult to execute the slot filling (for example, it is difficult to execute the spoken language understanding) without waiting for the result of the speech recognition executed by the cloud apparatus. For an application needing a large amount of vocabularies, no process may thereby be started until the result of the speech recognition executed by the cloud apparatus is received and, for example, the starting time is delayed. This delay includes the time period for the speech recognition in the cloud apparatus and, in addition, the time period for the transmission and the reception of the input speech and the result of the speech recognition between the local terminal and the cloud apparatus. The start of the processing is therefore significantly delayed in the case where the hybrid speech recognition is applied to the application that needs the large amount of vocabularies. This is the problem of the above method for the realization.

In view of the above, it is desirable to suppress any delay occurred when an application is executed after executing spoken language understanding based on the hybrid speech recognition.

### SUMMARY

According to an aspect of the embodiments, a non-transitory computer-readable storage medium storing a program that causes a processor included in a spoken language understanding apparatus to execute a process, the process includes executed by a first apparatus that is a computer, executing a first slot filling process for a first slot that corresponds to a first application and a second slot that corresponds to a second application based on a result of first speech recognition executed by the first apparatus for a speech signal, executing determination as to whether a result of a second slot filling process executed for the second slot based on second speech recognition executed for the speech signal by a second apparatus coupled to the first apparatus by a network is employed, based on a result of the first slot filling process, and executing the first application or the second application based on a result of the determination.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a hardware block diagram of a hybrid speech recognition system;

FIG. 2 is a functional block diagram of a hybrid speech recognition system;

FIG. 3 is an image diagram of scales of speech recognition language models;

FIG. 4 is a flowchart of a determination process based on a result of a slot filling process;

FIGS. 5A and 5B are image diagrams of slot filling for each application;

FIG. 6 is a first image diagram of a slot filling process;

FIG. 7 is a second image diagram of a slot filling process;

FIG. 8 is a third image diagram of a slot filling process; and

FIG. 9 is a fourth image diagram of a slot filling process.

### DESCRIPTION OF EMBODIMENTS

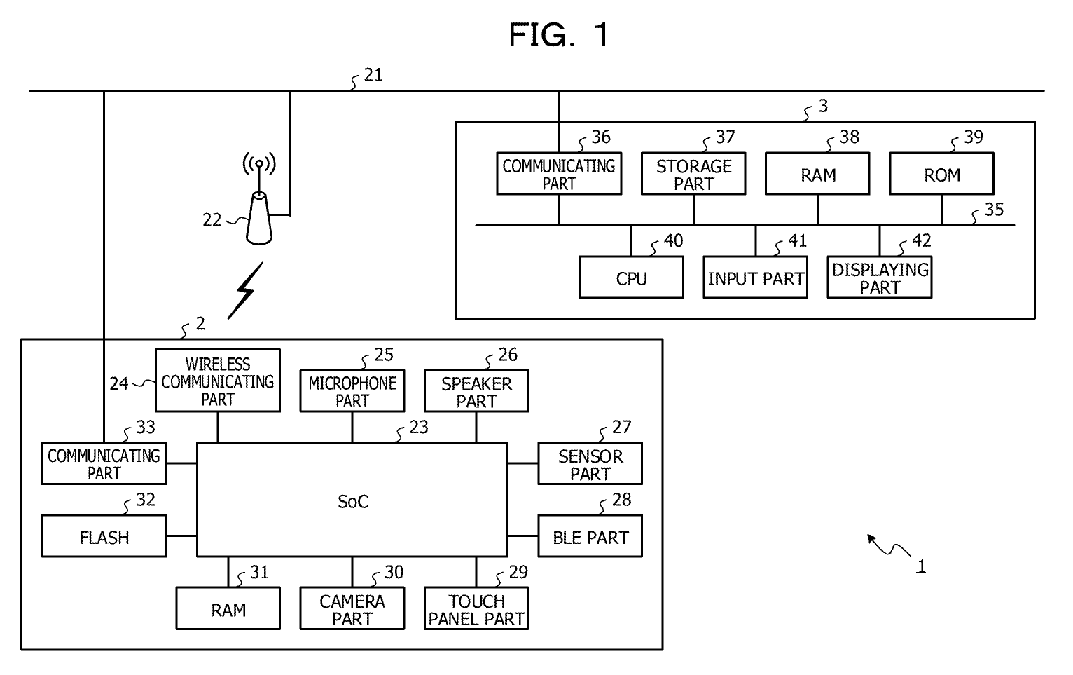

FIG. 1 is a hardware block diagram of a hybrid speech recognition system. In FIG. 1, a hybrid speech recognition system 1 includes a local terminal 2, a cloud apparatus 3, and a router 22. The local terminal 2, the cloud apparatus 3, and the router 22 are coupled to each other by a network 21. The local terminal 2 may be coupled to the network 21 through a wireless communication coupling with the router 22 or by a wired communication coupling.

The local terminal 2 functions as a spoken language understanding apparatus that accepts a speech input from a user and that executes spoken language understanding based on a speech recognition process, for the user. The local terminal 2 is a computer such as a personal computer, a tablet, a smartphone, or a mobile phone. The local terminal 2 includes an SoC 23, a wireless communicating part 24, a microphone part 25, a speaker part 26, a sensor part 27, a BLE part 28, a touch panel part 29, a camera part 30, a RAM 31, a FLASH 32, and a communicating part 33. The SoC 23 is electrically coupled to each of the wireless communicating part 24, the microphone part 25, the speaker part 26, the sensor part 27, the BLE part 28, the touch panel part 29, the camera part 30, the RAM 31, the FLASH 32, and the communicating part 33.

The SoC 23 is a system on a chip. The SoC 23 includes a central processing unit (CPU) that is a central processing device and a system to control the functions of the local terminal 2. The SoC 23 is a processor that reads an operating system (OS) stored in, for example, the FLASH 32 and executes the various functions of the local terminal 2.

The wireless communicating part 24 executes the wireless communication coupling between the router 22 and the local terminal 2. The wireless communication coupling is a coupling using a wireless local area network (LAN) such as wireless fidelity (Wi-Fi). The coupling between the local terminal 2 and the network 21 may be a coupling using mobile communication such as long term evolution (LTE), or may be a wired coupling by the communicating part 33.

The microphone part 25 receives a speech input from the user and converts the air vibrations thereof into an electric signal. The microphone part 25 may include an analog to digital converter (ADC) that converts an analog electric signal into a digital signal.

The speaker part 26 delivers the result of the processing by the SoC 23 to the user as an analog speech. The speaker part 26 may include a digital to analog converter (DAC) that converts a digital signal to be the result of the processing by the SoC 23 into an analog signal.

The sensor part 27 converts information relating to the peripheral environment of the local terminal 2 into a digital signal. The sensor part 27 is, for example, a temperature sensor, a humidity sensor, an acceleration sensor, or a GPS. In the above, the GPS is the abbreviation of the global positioning system, and is an apparatus that measures the current position on the earth based on a radio wave from artificial satellites. The sensor part 27 may regularly or irregularly collect sensing data based on various types of sensors and may transmit the sensing data to the SoC 23.

The BLE part 28 is Bluetooth low energy that is one of the extended specifications of Bluetooth (registered trademark) that is a short-distance wireless communication technique. The BLE part 28 realizes short-distance wireless communication between the local terminal 2 and an external apparatus.

The touch panel part 29 is an electronic part formed by combining a display device like a liquid crystal panel and a position input device like a touch pad. The user may operate the local terminal 2 by pressing the display on the touch panel part 29.

The camera part 30 is a device to shoot a video image. The camera part 30 transmits data of the shot video image to the SoC 23.

The RAM 31 is a random access memory that is a type of storage device. The RAM 31 temporarily stores therein, for example, the result of computing processing executed by the SoC 23.

The FLASH 32 is a flash memory that is a type of non-volatile storage device. The FLASH 32 stores therein, for example, the OS to be executed by the SoC 23 and a spoken language understanding program to realize the present embodiment.

The communicating part 33 couples the local terminal 2 and the network 21 to each other using a wire line. In the case, for example, where the wireless communication coupling between the wireless communicating part 24 and the router 22 is unstable, the coupling between the local terminal 2 and the network 21 may be stabilized by using the communicating part 33. The cloud apparatus 3 may be coupled to the network 21 by the wireless communication similarly to the local terminal 2.

The cloud apparatus 3 executes a speech recognition process whose precision is higher than that of the local terminal 2, utilizing a computer resource that is larger than that of the local terminal 2, based on the speech signal received from the local terminal 2. The cloud apparatus 3 is an example of an apparatus or a system whose computer resource is relatively large and, instead of this, a grid computing system by plural apparatuses, a single server apparatus, or the like may be used.

A bus 35 couples the parts in the cloud apparatus 3 to each other. A communicating part 36 couples the cloud apparatus 3 and the network 21 to each other by wired communication. The storage part 37 is a storage device other than a RAM 38 and a ROM 39 described later and is, for example, a hard disk drive (HDD) or a solid state drive (SSD). The RAM 38 is a random access memory and temporarily stores therein data. The ROM 39 is a read-only memory and stores therein programs such as a basic input output system (BIOS). A CPU 40 executes, for example, the OS stored in the storage part 37. An input part 41 is a keyboard and a mouse for the user to input the execution conditions for the programs into the cloud apparatus 3. A displaying part 42 is a display to show the result of the processing by the CPU 40 and the like to the user.

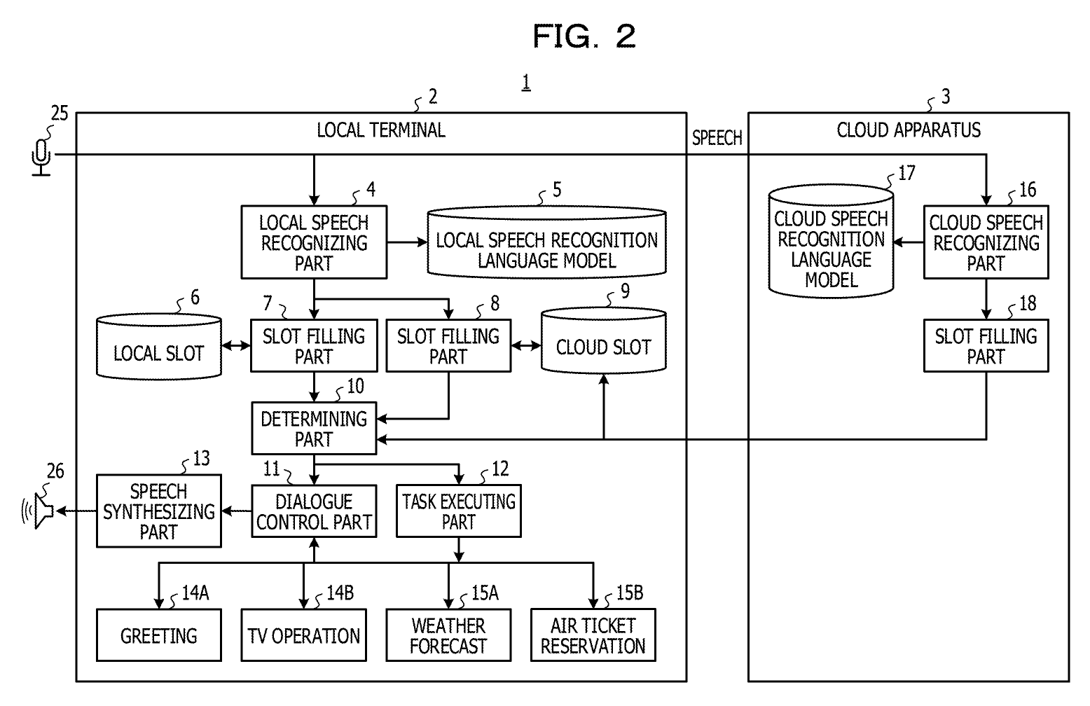

FIG. 2 is a functional block diagram of a hybrid speech recognition system. For the hybrid speech recognition system 1 in FIG. 2, blocks corresponding to the hardware configurations in FIG. 1 are given the same reference numerals.

For the local terminal 2, functions of a local speech recognizing part 4, a slot filing part 7, a slot filling part 8, a determining part 10, a speech synthesizing part 13, a dialogue control part 11, an executing part 12, and applications 14A and 14B or 15A and 15B are realized by reading and executing the spoken language understanding program stored in the FLASH 32 by the SoC 23 in FIG. 1. A local speech recognition language model 5, a local slot 6, and a cloud slot 9 are stored in the FLASH 32, the RAM 31, and the like.

The microphone part 25 AD-converts the received analog speech and transmits a digital speech signal to the local speech recognizing part 4 of the local terminal 2 and a cloud speech recognizing part 16 of the cloud apparatus 3.

The local speech recognizing part 4 in the local terminal 2 executes the speech recognition process based on the local speech recognition language model 5 for the received digital speech signal. The local speech recognition language model 5 records therein linguistic characteristics such as restrictions concerning the arrangement of the phonemes for the speech recognition process, as a language model.

The cloud speech recognizing part 16 in the cloud apparatus 3 executes the speech recognition process based on the cloud speech recognition language model 17 for the received digital speech signal. Similarly to the local speech recognition language model 5, the cloud speech recognition language model 17 records therein the linguistic characteristics such as the restrictions concerning the arrangement of the phonemes for the speech recognition process, as a language model.

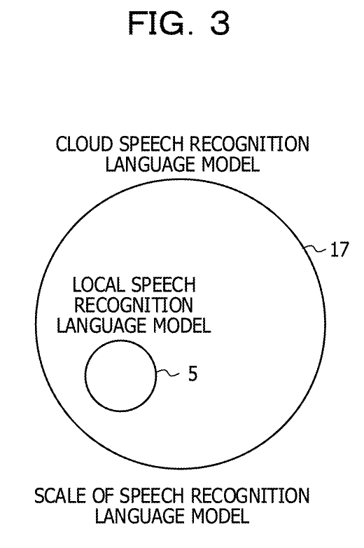

FIG. 3 is an image diagram of scales of speech recognition language models. In FIG. 3, the size of each of circles represents the data size of each of the speech recognition language models. In FIG. 3, the data size of the cloud speech recognition language model 17 is larger than the data size of the local speech recognition language model 5.

In the speech recognition process, the number of the recognizable vocabularies is increased as the number of the language models to be referred to is increased while the amount of the hardware resource is increased that is used for a comparison reference process for the input digital speech and the language models. The scale of the local speech recognition language model 5 in the local terminal 2 that tends to receive the restrictions on the computer resource is therefore smaller than that of the cloud speech recognition language model 17 in the cloud apparatus 3 that tends to avoid any restriction on the computer resource. The number of the recognizable vocabularies of the speech recognition process executed by the local speech recognizing part 4 is therefore smaller than that of the cloud speech recognizing part 16. On the other hand, the number of the recognizable vocabularies of the cloud speech recognizing part 16 is greater than that of the local speech recognizing part 4 while the starting timing of the speech processing by the cloud speech recognizing part 16 is later than that of the local speech recognizing part 4 because the cloud speech recognizing part 16 receives the digital speech signal through the network 21. The scale of the cloud speech recognition language model 17 to which the cloud speech recognizing part 16 refers is larger than that of the local speech recognition language model 5. The cloud speech recognizing part 16 therefore completes the speech recognition process later than the local speech recognizing part 4 does.

The local speech recognizing part 4 transmits the result of the speech recognition process to the slot filing part 7 and the slot filling part 8. The cloud speech recognizing part 16 transmits the result of the speech recognition process to a slot filling part 18.

The slot filling parts 7 and 8 each execute a slot filling process for the slots (the local slot 6 and the cloud slot 9) based on the received result of the speech recognition process. As above, the slot filling is a process that is executed for the spoken language understanding. For each of the applications using the result of the speech recognition, a slot set including one or more slots is prepared. In the above, a slot is a fragment of the data to be obtained to satisfy the intent of the user, and the intent represents a goal that the user desires to accomplish (such as turning on a television (TV), purchasing an air ticket, or obtaining a weather forecast). The slot filling process is a process of filling the slots prepared to satisfy each intent with data obtained based on the result of the speech recognition process and thereby executing the spoken language understanding.

Relating to the above, in the present embodiment, an application executable at a high probability even using the speech recognition using a relatively small amount of vocabularies (for example, an application for which sufficient slots are filled at a high probability even using the speech recognition using a relatively small amount of vocabularies) is referred to as “local application 14.” In contrast, an application not executable at a high probability without using the speech recognition using a relatively large amount of vocabularies (for example, an application for which sufficient slots are not filled at a high probability using the speech recognition using a relatively small amount of vocabularies) is referred to as “cloud application 15.” In the above, the “cloud application 15” is a name for convenience and it is noted that the cloud application 15 does not necessarily need to be executed by the cloud apparatus 3. In the present embodiment, as described later, the local application 14, and besides, the cloud application 15 are executed by the local terminal 2.

A slot (a slot set) corresponding to the local application 14 is referred to as “local slot 6.” In contrast, a slot (a slot set) corresponding to the cloud application 15 is referred to as “cloud slot 9.” These names are also for convenience and, in the present embodiment, the cloud slot 9 may be updated by both the cloud apparatus 3 and the local terminal 2.

The local terminal 2 includes the two slot filling parts 7 and 8. The slot filling part 7 executes slot filling for the local slot 6 based on the result of the speech recognition executed by the local speech recognizing part 4. On the other hand, the slot filling part 8 executes slot filling for the cloud slot 9 based on the result of the speech recognition executed by the local speech recognizing part 4.

In contrast, the cloud apparatus 3 includes the one slot filling part 18. Similarly to the slot filling part 8, the slot filling part 18 executes the slot filling process for the cloud slot 9 of the local terminal 2. In practice, the slot filling part 18 executes the slot filling process for a cloud slot (not depicted) included in the cloud apparatus 3, transmits the result of this process to the local terminal 2, and may thereby update the cloud slot 9 in the local terminal 2.

The determining part 10 executes presumption for the intent of the user based on the result of the slot filling process executed for the local slot 6 and the cloud slot 9, and executes determination (mediation) as to which one of the results of the slot filling processes is used to satisfy the intent of the user (for example, which application is to be executed). The determining part 10 transmits information relating to the presumed intent of the user and slot data of the local slot 6 or the cloud slot 9, to the dialogue control part 11 and the executing part 12. The details of the process executed by the determining part 10 will be described later.

The dialogue control part 11 outputs a question demanding additional information, and the like to the user when any slot whose value is insufficient is present. The dialogue control part 11 transmits the results of the processing by the applications (the local application 14 and the cloud application 15) to the speech synthesizing part 13.

The executing part 12 selects and executes the local application 14 or the cloud application 15 described above based on the received information relating to the intent and the received slot data. The local application 14 or the cloud application 15 may each be a stand-alone-type application or may each be a client-type application. For example, an application that returns a greeting based on the speech recognition and an application that operates a home appliance based on the speech recognition may each be realized as a stand-alone-type application. On the other hand, an air ticket reservation, a weather forecast, and the like based on the speech recognition are each realized as a client-type application because inquiries to a server (not depicted) may be usually necessary. The client-type application transmits a request based on the result of the spoken language understanding (for example, the conditions for an airplane for which the user desires to make a reservation for a ticket) to the server, receives the response to the request (for example, the result of the air ticket reservation) from the server, and thereby provide the user with a service.

The speech synthesizing part 13 executes a speech synthesis process in accordance with the received result of the processing and transmits a speech signal to the speaker part 26. The speaker part 26 outputs a speech in accordance with the received speech signal.

The output of the speech is only an example of the output by the application, and the application may execute an output other than this. The output of the application such as the one that returns a greeting is an output as a speech while the output of an application such as the one that operates a TV is a wireless signal to control the TV and the output of an application such as the one that makes a reservation for an air ticket may be formed as an output on a screen, that relates to the result of the air ticket reservation.

A greeting 14A and a TV operation 14B are examples of the local application 14 described above. A weather forecast 15A and an air ticket reservation 15B are examples of the cloud application 15 described above. These are only exemplification, and the type and the number of the applications are naturally not limited to these.

As above, the hybrid speech recognition system 1 may efficiently and properly determine the intent of the user based on the results of the slot filling processes executed by the local terminal 2 and the cloud apparatus 3, and may execute the process for responding to the user.

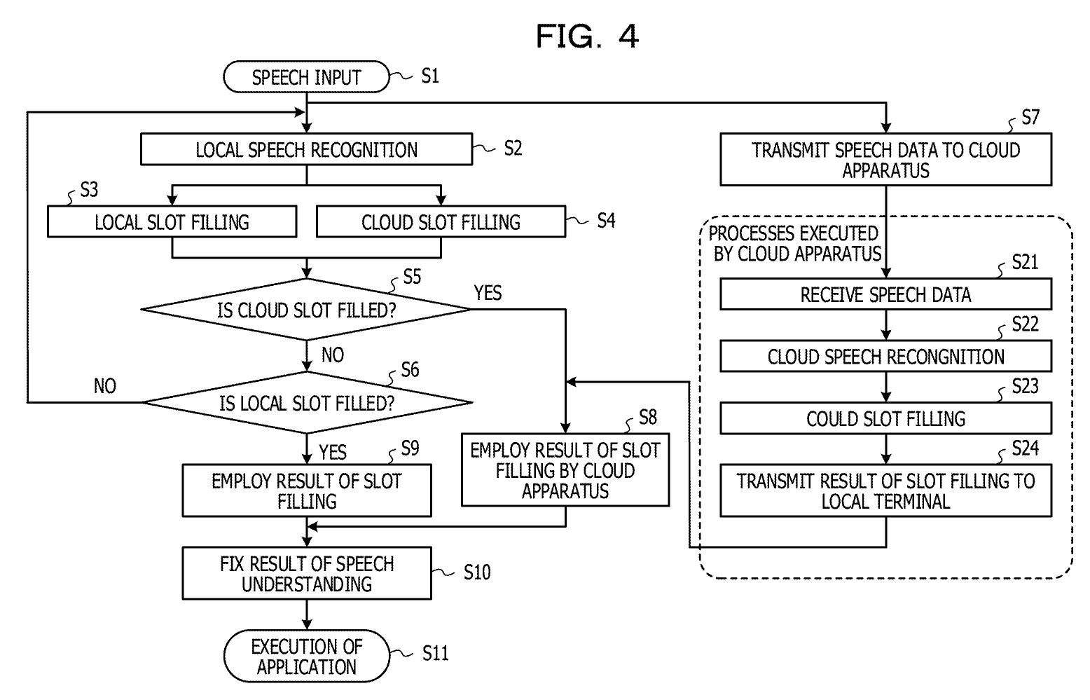

FIG. 4 is a flowchart of a determination process based on a result of a slot filling process. The local terminal 2 executes the determination process for the result of the slot filling process (for example, the result of the spoken language understanding process) in accordance with the flowchart in FIG. 4, for the received speech input.

The local terminal 2 receives the speech input from the user using the microphone part 25 (step S1). The local terminal 2 converts the received speech input into the digital signal and transmits the speech data to the cloud apparatus 3 (step S7). The cloud apparatus 3 receives the speech data transmitted from the local terminal 2 (step S21). The cloud apparatus 3 executes the cloud speech recognition process using the cloud speech recognizing part 16 (step S22). The cloud apparatus 3 executes the cloud slot filling process (step S23). The cloud apparatus 3 transmits the result of the processing for the cloud slot filling to the local terminal 2 (step S24).

The cloud apparatus 3 starts the speech recognition process later than the local terminal 2 does because the cloud apparatus 3 receives the speech data input into the local terminal 2 through the network 21. Because the cloud apparatus 3 has the resource more sufficient than that of the local terminal 2, the scale of the cloud speech recognition language model 17 to be referred to in the speech recognition is larger than that of the local speech recognition language model 5. The search load in the speech recognition process becomes heavier and the time period for the speech recognition process becomes longer as the scale of the speech recognition language model to be referred to become larger. The slot filling process executed by the local terminal 2 is therefore highly likely to be completed at the time point at which the cloud apparatus 3 transmits the result of the slot filling process to the local terminal 2. The cloud speech recognition however has more vocabularies than those of the local speech recognition because the scale of the cloud speech recognition language model 17 is larger than that of the local speech recognition language model 5. The cloud application 15 may need the result of the processing for the cloud slot filling based on the cloud speech recognition even when the time period for the speech recognition process is long. The local terminal 2 therefore executes the slot filling process as below and determines whether or not the local terminal 2 employs (obtains) the result of the slot filling process executed by the cloud apparatus 3, based on the result of the slot filling process executed thereby.

The local terminal 2 converts the received speech input into the digital signal and executes the local speech recognition using the local speech recognizing part 4 (step S2). The local terminal 2 executes the local slot filling process of filling the local slot 6 based on the result of the local speech recognition process (step S3). In parallel to the local slot filling process, the local terminal 2 executes the cloud slot filling process of filling the cloud slot 9 based on the result of the local speech recognition process (step S4).

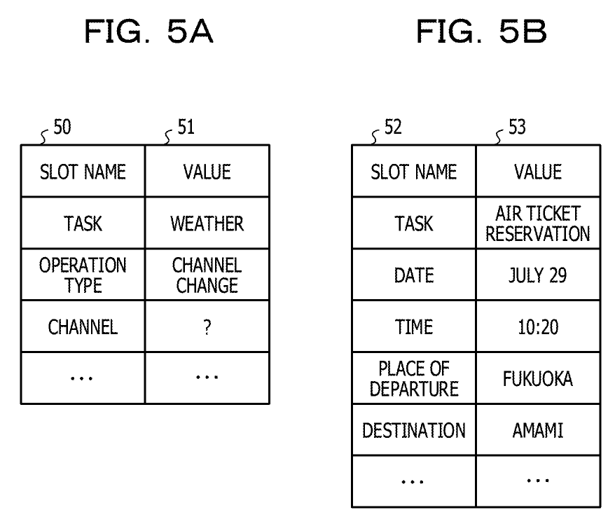

FIGS. 5A and 5B are image diagrams of slot filling for each of applications. FIG. 5A is an image diagram of the slot filling (a slot set) for the TV operation application 14B. The TV operation application 14B is an example of the local application 14. On the other hand, FIG. 5B is an image diagram of the slot filling (a slot set) of the air ticket reservation application 15B. The air ticket reservation application 15B is an example of the cloud application 15.

In FIG. 5A, a column 50 presents slot names and a column 51 presents values that correspond to the slots. Similarly, in FIG. 5B, a column 52 presents slot names and a column 53 presents values that correspond to the slots.

For the slot names in each of the column 50 and the column 52, a slot with a name of “task” is present. In this example, an application to be executed may be identified in accordance with the content of the slot of “task.” A slot like this is called “key slot.” Plural key slots may be present in one slot depending on the configuration of the slot set. As an example thereof, for example, for the slot set in FIG. 5A, the case is present where, even when the word “TV” is not pronounced, the slots for “operation type” and “channel” are filled from a speech of “change the channel to channel 8” and the application to be executed may be identified to be the TV operation application.

In the case where a value corresponding to “TV” is input in a slot for the task, that is the key slot in the slot filling (the local slot filing) depicted in FIG. 5A, the local terminal 2 executes the slot filling for the remaining slots depicted in FIG. 5A (such as those for the operation type and the channel to be designated) to execute the TV operation application 14B. On the other hand, in the case where a value corresponding to “air ticket reservation” is input in the slot for the task, that is the key slot in the slot filling (the cloud slot filling) depicted in FIG. 5B, the local terminal 2 executes the slot filling for the remaining slots depicted in FIG. 5B (such as those for the date, the time of day, and the place of departure) to execute the air ticket reservation application 15B.

Referring back to the description of FIG. 4, the local terminal 2 executes a determination process as to which one of the results of the slot filling processes is employed based on the results of the slot filling processes executed by the local slot 6 and the cloud slot 9. The local terminal 2 first checks whether or not the key slot of the cloud slot 9 processed by the local terminal 2 is filled (step S5). In the case where the local terminal 2 determines that the key slot of the cloud slot is filled (step S5: YES), the local terminal 2 employs the result of the cloud slot filling process received from the cloud apparatus 3 (step S8). The local terminal 2 causes the result of the spoken language understanding based on the hybrid speech recognition to be fixed using the employed result of the cloud slot filling process (step S10) and executes the cloud application 15 that corresponds thereto (step S11).

On the other hand, in the case where the local terminal 2 determines that the key slot of the cloud slot processed by the local terminal 2 is not filled (step S5: NO), the local terminal 2 checks whether or not the key slot of the local slot 6 processed by the local terminal 2 is filled (step S6). In the case where the local terminal 2 determines that the key slot of the local slot 6 is filled (step S6: YES), the local terminal 2 employs the result of the local slot filling process processed by the local terminal 2 (step S9). The local terminal 2 causes the result of the spoken language understanding based on the hybrid speech recognition to be fixed using the employed result of the local slot filling process (step S10) and executes the local application 14 that corresponds thereto (step S11).

In the case where the local terminal 2 determines that the local slot 6 is not filled (step S6: NO), the local terminal 2 continues the slot filling process at and after step S2. In the case where the local terminal 2 determines that the local slot 6 is not filled, the local terminal 2 may produce questions for the user to obtain information relating to the slots not filled, and may deliver the questions to the user from the speaker part 26 by controlling the dialogue control part 11. The local terminal 2 may obtain the information relating to the slots not filled by receiving the answers to the questions as speeches, from the user.

As above, the cloud application assumes the cloud speech recognition that has the abundant vocabularies. As has been described, however, when the processing concerning the cloud application is started after waiting for the cloud speech recognition, the starting time is delayed. In contrast, in the present embodiment, in addition to the local slot filling, the cloud slot filling is also executed using the result of the local speech recognition without waiting for the cloud speech recognition. The reason for this is that, admitting that the cloud speech recognition is often finally used for completing the cloud slot filling, it may be considered that the cloud slots may often be filled to some extent using the result of the local speech recognition. For example, for the slots for the place of departure, the destination, and the like in the slot set that corresponds to the air ticket reservation application, the cloud speech recognition may be necessary to recognize proper nouns while, for “air plane” that is the key slot, this is a basic word and this key slot may therefore be sufficiently filled using the local speech recognition. At least which slot set needs to be filled (for example, which application needs to be executed) may be determined without waiting for the cloud speech recognition, by executing as above. In addition, the cloud speech recognition may need to finally be waited for in the cloud slot filling while the process for filling the slots (such as the inquiry to the user) may also be advanced to some extent during this waiting. In accordance with the above, in the present embodiment, even for the cloud application that assumes the cloud speech recognition that has the abundant vocabularies, the spoken language understanding may be executed and the related processes may be started without waiting for the result of the cloud speech recognition.

As above, the hybrid speech recognition system 1 may increase the response speed selecting a proper speech recognition by determining whether or not the speech recognition executed by the cloud apparatus 3 based on the result of the slot filling process executed by the local terminal 2 in accordance with the content of a speech input. As a result, any delay occurred when an application is executed may be suppressed after executing the spoken language understanding based on the hybrid speech recognition.

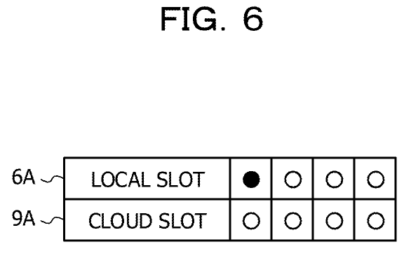

FIG. 6 is a first image diagram of a slot filling process. In FIG. 6, a row 6A presents the result of the slot filling process for the local slot 6 and a row 9A presents the result of the slot filling process for the cloud slot 9. In FIG. 6, the local slot 6 and the cloud slot 9 each include four slots, and the leftmost slot is set to be the key slot. White circles in the row 6A and the row 9A are each represent an empty slot having no data present therein. A black circle in the row 6A represents a slot having data present therein.

In the case where data is present in the local slot 6 and no data is present in the cloud slot 9 as in FIG. 6 as the result of the slot filling process, the local terminal 2 advances the dialogue control process based on the result of the slot filling process executed by the local terminal 2 without waiting for the result of the slot filling process executed by the cloud apparatus 3. For example, the local terminal 2 produces questions to fill the empty slots based on the result of the slot filling process executed for the local slots 6, and outputs the produced questions to the user as a speech signal. The local terminal 2 may execute the speech recognition process at a high response speed in response to the speech input from the user by outputting the questions to the user based on the result of the slot filling process for the local slot 6.

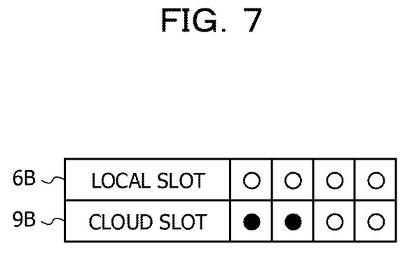

FIG. 7 is a second image diagram of a slot filling process. A row 6B and a row 9B in FIG. 7 correspond to the row 6A and the row 9A in FIG. 6 and therefore will not be described.

As the result of the slot filling process, in the case where data is present in the cloud slot 9 and no data is present in the local slot 6 as in FIG. 7, the local terminal 2 determines that the result of the slot filling process executed by the cloud apparatus 3 may be necessary. After the local terminal 2 receives the result of the slot filling process executed by the cloud apparatus 3, the local terminal 2 advances the dialogue control process using the result of the slot filling process executed by the local terminal 2 together therewith. For example, the local terminal 2 produces the questions to fill the empty slots based on the result of the slot filling process for the local slot 6 and the result of the slot filling process executed by the cloud apparatus 3, and outputs the questions to the user as a speech signal. The local terminal 2 may highly reliably execute the speech recognition process as necessary in response to a complicated request from the user by outputting the questions to the user based on the result of the slot filling process for the cloud slot 9 and the result of the slot filling process executed by the cloud apparatus 3.

Relating to the above, in the flowchart depicted in FIG. 4 above, the relatively ordinary case is assumed where either one of the key slot of the local slot 6 and the key slot of the cloud slot 9 is filled as in FIG. 6 and FIG. 7. In practice, however, the case where both the key slot of the local slot 6 and the key slot of the cloud slot 9 are filled and the case where both thereof are not filled may occur. These cases will be described below.

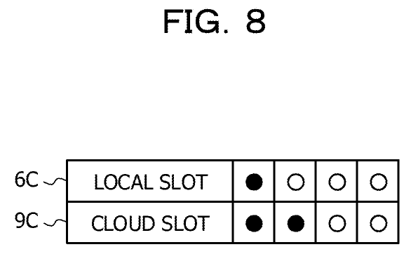

FIG. 8 is a third image diagram of a slot filling process. A row 6C and a row 9C in FIG. 8 correspond to the row 6A and the row 9A in FIG. 6 and therefore will not be described.

FIG. 8 depicts the case where the key slots of both the cloud slot 9 and the local slot 6 are exceptionally filled. Any one of some processes may be considered as the process to be executed in this case in accordance with the strategy/policy of the speech dialogue. For example, the fastness of the response speed is prioritized and the local application 14 corresponding to the local slot 6 is executed. The understanding of the intent of the user is prioritized, the result of the slot filling executed by the cloud apparatus 3 is waited for to be obtained, and the cloud application 15 is executed. In addition, both of these may be executed with a time difference therebetween.

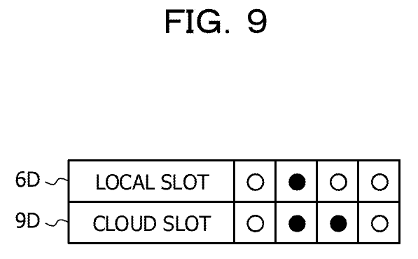

FIG. 9 is a fourth image diagram of a slot filling process. A row 6D and a row 9D in FIG. 9 correspond to the row 6A and the row 9A in FIG. 6 and will therefore not be described.

FIG. 9 depicts the case where none of the key slots of the cloud slot 9 and the local slot 6 are exceptionally filled. Any one of some processes may be considered as the process to be executed in this case in accordance with the strategy/policy of the speech dialogue. For example, which one of the cloud slot 9 and the local slot 6 includes more filled slots may be determined and the application of the one including more filled slots may be executed. The fastness of the response speed may also be prioritized and the local application 14 may be executed without waiting for the cloud speech recognition. Furthermore, the abundance of the vocabularies in the speech recognition may also be prioritized and the cloud application 15 may be executed after waiting for the cloud speech recognition. In this case, because it is difficult to execute the cloud application 15 immediately, the cloud slot 9 may be updated after waiting for the result of the cloud slot filling executed by the cloud apparatus 3. The understanding of the intent of the user may also be prioritized and the speech recognition and the slot filling may again be executed by outputting a speech that urges the user to again speak, such as “please speak again.”

The object and the advantages of the embodiments discussed herein are realized and achieved by, for example, the elements described in the appended claims and combinations thereof. Both the description as above and the detailed description as below are exemplary and explanatory, and do not limit the embodiments discussed herein as the appended claims do.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing a program that causes a processor included in a spoken language understanding apparatus to execute a process, the process comprising:
executed by a first apparatus that is a computer,
executing a first slot filling process for a first slot that corresponds to a first task and a second slot that corresponds to a second task based on a result of first speech recognition executed by the first apparatus for a speech signal;
executing determination as to whether a result of a second slot filling process executed for the second slot based on second speech recognition executed for the speech signal by a second apparatus coupled to the first apparatus by a network is employed, based on a result of the first slot filling process; and
executing the first task or the second task based on a result of the determination.

2. The non-transitory computer-readable storage medium according to claim 1, wherein
the process further includes:
transmitting the speech signal to the second apparatus through the network; and
receiving a result of the second slot filling process from the second apparatus in a case where the first apparatus executes the determination to the effect that the result of the second slot filling is employed.

3. The non-transitory computer-readable storage medium according to claim 2, wherein
the first slot includes a first key slot, and
the process further includes:
executing the determination to the effect that the result of the second slot filling process is not employed, in a case where the first key slot is filled in the first slot filling process; and
executing the first task without waiting for the second slot filling process.

4. The non-transitory computer-readable storage medium according to claim 3, wherein
the second slot includes a second key slot, and
the process further includes:
executing the determination to the effect that the result of the second slot filling is employed, in a case where the second key slot is filled in the first slot filling process; and
executing the second task based on the result of the second slot filling process.

5. The non-transitory computer-readable storage medium according to claim 3, wherein
the process further includes:
executing the determination to the effect that the result of the second slot filling process is not employed, in a case where both the first key slot and the second key slot are filled in the first slot filling process; and
executing the first task without waiting for the second slot filling process.

6. The non-transitory computer-readable storage medium according to claim 3, wherein
the process further includes:
executing the determination to the effect that the result of the second slot filling process is employed, in a case where both the first key slot and the second key slot are filled in the first slot filling process; and
executing the second task based on the result of the second slot filling process.

7. The non-transitory computer-readable storage medium according to claim 3, wherein
the process further includes:
executing the determination to the effect that the result of the second slot filling process is employed, in a case where none of the first key slot and the second key slot are filled in the first slot filling process; and
executing the second task based on the result of the second slot filling process.

8. The non-transitory computer-readable storage medium according to claim 3, wherein
the second apparatus is an apparatus having a computer resource whose scale is larger than a scale of a computer resource of the first apparatus.

9. The non-transitory computer-readable storage medium according to claim 3, wherein
the second task needs speech recognition whose vocabularies are more abundant than vocabularies of speech recognition of the first task.

10. A spoken language understanding apparatus comprising:
a memory; and
a processor coupled to the memory and configured to
execute a first slot filling process for a first slot that corresponds to a first application and a second slot that corresponds to a second application based on a result of a first speech recognition executed by the spoken language understanding apparatus for a speech signal,
determine whether a result of a second slot filling process executed for the second slot based on second speech recognition for the speech signal by another apparatus coupled to the spoken language understanding apparatus by a network is employed, based on a result of the first slot filling process, and
execute the first application or the second application based on a result of the determination.

11. A spoken language understanding method comprising:
executing, by a spoken language understanding apparatus, a first slot filling process for a first slot that corresponds to a first application and a second slot that corresponds to a second application based on a result of first speech recognition executed by the spoken language understanding apparatus for a speech signal;
executing, by the spoken language understanding apparatus, determination as to whether a result of a second slot filling process executed for the second slot based on second speech recognition executed for the speech signal by another apparatus coupled to the spoken language understanding apparatus by a network, based on a result of the first slot filling process; and
executing, by the spoken language understanding apparatus, the first application or the second application based on a result of the determination.
